(19) United States
(12) Patent Application Publication
(10) Pub. No.: US 2026/0028268 A1
(43) Pub. Date: Jan. 29, 2026

(54) INORGANIC COMPOSITION ARTICLE

(71) Applicant: OHARA INC., KANAGAWA (JP)

(72) Inventors: KOHEI OGASAWARA, KANAGAWA (JP); SAYA KIKKAWA, KANAGAWA (JP); TOSHITAKA YAGI, KANAGAWA (JP)

(21) Appl. No.: 18/994,649

(22) PCT Filed: Jul. 13, 2023
(86) PCT No.: PCT/JP2023/025856

§ 371 Date: Jan. 15, 2025

(30) Foreign Application Priority Data
Jul. 15, 2022 (JP) 2022-114277

(51) Int. Cl. C03C 10/00; C03C 21/00

(52) U.S. Cl. CPC C03C 10/0009; C03C 10/0054; C03C 21/002

(57) ABSTRACT

An inorganic composition article obtained by strengthening a crystallized glass, wherein the crystallized glass comprises one or more kinds selected from α-cristobalite and α-cristobalite solid solution as a main crystal phase, the crystallized glass comprises, by mass % in terms of oxide, a content of a SiO₂ component of 50.0% to 75.0%, a content of a Li₂O component of 3.0% to 10.0%, a content of an Al₂O₃ component of 5.0% or more and less than 15.0%, a content of a B₂O₃ component of more than 0% and 10.0% or less, a content of a P₂O₅ component of more than 0% and 10.0% or less, and a mass proportion SiO₂/(B₂O₃+Li₂O) of 3.0 to 10.0, and the inorganic composition article has a compressive stress layer on the surface, and has a central tensile stress (CT) of 80 MPa to 160 MPa.

### FIELD OF THE DISCLOSURE

The present disclosure relates to an inorganic composition article, such as a strengthened crystallized glass, having a compressive stress layer thereon.

Various types of glass are expected to be used as a cover glass for protecting a display or a housing of a portable electronic device such as a smartphone or a tablet PC, as well as a protector for protecting lens of an in-vehicle optical apparatus, bezel or a console panel for interior, a touch panel material, a smart key, and the like. These devices are required to be used in harsh environments, which increases the demand for glass having higher strength.

Conventionally, a chemically strengthened glass is used as a material for use in a protective member or the loke. However, conventional chemically strengthened glasses are often damaged when a portable device such as a smart phone is dropped. In particular, there is a need for a crystallized glass that is less likely to crack when dropped onto uneven and rough surfaces like asphalt.

When a central tensile stress (CT [MPa]) is high, pieces caused by breaking of a glass tend to be small and smashed into smithereens. When used as a protective member or the like, a glass surface may be polished before use. There was a need for a glass to be kept high CT prior to polish, since CT is lowered when the glass surface is polished. However, when a polishing step is not conducted, CT would be too high which would cause a problem in that when the glass broke, pieces of glass became too small and shattered. Thus, there has been a demand for a glass with a CT that was not too high, which could be used even when a polishing process is not conducted.

Patent Document 1 discloses a material composition of a crystallized glass substrate for an information recording medium that can be chemically strengthened. Patent Document 1 says that an α-cristobalite-based crystallized glass described in Patent Document 1 can be chemically strengthened and may be utilized as a material substrate with high strength. However, crystallized glasses for an information recording medium such as substrate for hard disk ware not intended for use in a harsh environment.

### PRIOR ART DOCUMENT

### Patent Document

Patent Document 1: JP 2008-254984 A

### SUMMARY OF THE DISCLOSURE

An object of the present disclosure is to provide an inorganic composition article such as a strengthened crystallized glass that is hardly broken when dropped onto a rough surface. Another object of the present disclosure is to provide an inorganic composition article such as a strengthened crystallized glass with a CT that is not too high.

The present disclosure provides the following.

### (Configuration 1)

An inorganic composition article obtained by strengthening a crystallized glass, wherein
the crystallized glass comprises one or more kinds selected from α-cristobalite and α-cristobalite solid solution as a main crystal phase,
the crystallized glass comprises, by mass % in terms of oxide,
a content of a SiO₂ component of 50.0% to 75.0%,
a content of a Li₂O component of 3.0% to 10.0%,
a content of an Al₂O₃ component of 5.0% or more and less than 15.0%,
a content of a B₂O₃ component of more than 0% and 10.0% or less,
a content of a P₂O₅ component of more than 0% and 10.0% or less, and
a mass proportion SiO₂/(B₂O₃+Li₂O) of 3.0 to 10.0, and
the inorganic composition article has a compressive stress layer on the surface, and has a central tensile stress (CT) of 80 MPa to 160 MPa.

### (Configuration 2)

The inorganic composition article according to configuration 1, wherein in the crystallized glass comprises, by mass % in terms of oxide,
a content of a ZrO₂ component is more than 0% and 10.0% or less, and
a total content of the Al₂O₃ component and the ZrO₂ component is 10.0% or more.

### (Configuration 3)

The inorganic composition article according to configuration 1 or 2, wherein in the crystallized glass, by mass % in terms of oxide,
a content of a K₂O component is 0% to 5.0%.

### (Configuration 4)

The inorganic composition article according to any one of configurations 1 to 3, wherein in the crystallized glass, by mass % in terms of oxide,
a content of a Na₂O component is 0% to 4.0%.
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

### (Configuration 5)

The inorganic composition article according to any one of configurations 1 to 4, wherein in the crystallized glass, by mass % in terms of oxide,
a content of a Nb₂O₅ component is 0% to 5.0%,
a content of a Ta₂O₅ component is 0% to 6.0%, and
a content of a TiO₂ component is 0% or more and less than 1.0%.

### (Configuration 6)

The inorganic composition article according to any one of configurations 1 to 5, wherein a glass transition temperature (Tg) of a glass before crystallization of the crystallized glass is 610° C. or less.

### (Configuration 7)

The inorganic composition article according to any one of configurations 1 to 6, which is obtained by chemically strengthening the crystallized glass using a salt-bath comprising lithium.

According to the present disclosure, by controlling the amount of LiO₂ and controlling the amount of SiO₂ and Al₂O₃, it becomes possible to easily and stably produce an inorganic composition article such as strengthened crystallized glass which is hardly broken when dropped onto a rough surface. Further, according to the present disclosure, it becomes possible to provide an inorganic composition article with a CT that is not too high.

The “inorganic composition article” in the present disclosure is composed of inorganic composition materials such as glass, crystallized glass, ceramics, or a composite material thereof. For example, the article of the present disclosure includes an article obtained by forming the inorganic material into a desired shape by processing or synthesizing by a chemical reaction is applicable to the article. In addition, a green compact obtained by crushing the inorganic materials and then pressurizing them, and a sintered body obtained by sintering the green compact, for example, also corresponds to the article. The shape of the article is not limited in smoothness, curvature, size, and the like. Examples of the shape include a plate-shaped substrate, a formed body having a curvature, and a three-dimensional structure having a complicated shape. A chemically strengthened inorganic composition material is also included therein.

Taking advantage of being a glass material with high strength and processability, the inorganic composition article according to the present disclosure may be utilized as a protective member or the like for devices. It may be utilized as a cover glass or a housing of a smartphone, a member of a portable electronic device such as a tablet PC and a wearable terminal, and a protective protector, a member of a substrate for a head-up display, or the like used in a transport vehicle such as a car and an airplane. Also, it may be utilized for other electronic devices, machineries, a building member, a member for a solar panel, a member for a projector, a cover glass (windshield) for eyeglasses or watches, and the like.

### DETAILED DESCRIPTION OF THE EXEMPLARY EMBODIMENTS

Embodiments and examples of an inorganic composition article according to the present disclosure will be described in detail below. However, the present disclosure is not limited to the following embodiments and examples, and may be implemented by making modifications as appropriate within the scope of the purpose of the present disclosure.

The crystallized glass which is the base material for the present disclosure includes one or more types selected from α-cristobalite and α-cristobalite solid solution as a main crystal phase. The crystallized glass in which these crystal phases are precipitated has high mechanical strength.

The term “main crystal phase” as used herein corresponds to a crystal phase contained in the largest amount in the crystallized glass, as determined from a peak of X-ray diffraction pattern.

As used herein, a content of each component is expressed as “by mass % in terms of an oxide” for all components, unless otherwise specified. Here, “by mass % in terms of an oxide” means, if it is assumed that all the constituent components included in the crystallized glass are decomposed and converted into oxides, when a total amount of the oxides is 100 mass %, an amount of oxides in each of the components contained in the crystallized glass is expressed by mass %. As used herein, “A % to B %” represents A % or more and B % or less.

A crystallized glass which is the base material of the present disclosure includes, by mass % in terms of oxide,
a content of a SiO₂ component of 50.0% to 75.0%,
a content of a Li₂O component of 3.0% to 10.0%,
a content of an Al₂O₃ component of 5.0% or more and less than 15.0%,
a content of a B₂O₃ component of more than 0% and 10.0% or less,
a content of a P₂O₅ component of more than 0% and 10.0% or less, and
a mass proportion SiO₂/(B₂O₃+Li₂O) of 3.0 to 10.0.

By having the above main crystal phase and the composition, the crystallized glass has a low glass transition temperature, meltability of raw material is increased which makes production easier, and the obtained crystallized glass is easier to process such as 3D processing.

Hereinafter, the composition range of each of the components constituting the crystallized glass as a base material of the present disclosure is specifically explained.

The SiO₂ component is an essential component necessary for constituting one or more types selected from α-cristobalite and α-cristobalite solid solution. When the content of the SiO₂ components is 75.0% or less, it is possible to suppress an excessive increase in viscosity and deterioration in meltability, and when the content is 50.0% or more, it is possible to suppress a deterioration in resistance to devitrification.

Preferably, the upper limit is 75.0% or less, 74.0% or less, 73.0% or less, 72.0% or less, or 70.0% or less. Preferably, the lower limit is 50.0% or more, 55.0% or more, 58.0% or more, or 60.0% or more.

The Li₂O component is a component that improves the meltability of the raw glass, when the content thereof is 3.0% or more, it is possible to improve the meltability of the raw glass, and when the content thereof is 10.0% or less, it is possible to suppress an increase in the generation of lithium disilicate crystal. The Li₂O component is also a component involved with chemical strengthening.

The lower limit is preferably 3.0% or more, 3.5% or more, 4.0% or more, 4.5% or more, 5.0% or more, or 5.5% or more. Further, preferably, the upper limit is 10.0% or less, 9.0% or less, 8.5% or less, or 8.0% or less.

The Al₂O₃ component is a component suitable for improving the mechanical strength of the crystallized glass. When the content of the Al₂O₃ component is less than 15.0%, it is possible to suppress a deterioration in meltability and resistance to devitrification, and when the content is 5.0% or more, it is possible to suppress a deterioration in mechanical strength.

Preferably, the upper limit is less than 15.0%, 14.5% or less, 14.0% or less, 13.5% or less, or 13.0% or less. Further, the lower limit may be 5.0% or more, 5.5% or more, 5.8% or more, 6.0% or more, 6.5% or more, or 8.0% or more.

The B₂O₃ component is a component suitable for lowering the glass transition temperature of the crystallized glass, and when the content thereof is 10.0% or less, it is possible to suppress a deterioration in chemical durability.

Preferably, the upper limit is 10.0% or less, 8.0% or less, 7.0% or less, 5.0% or less, or 4.0% or less. Further, preferably, the lower limit is more than 0%, 0.001% or more, 0.01% or more, 0.05% or more, 0.10% or more, or 0.30% or more.

The ZrO₂ component is a component capable of improving the mechanical strength, and when the content thereof is 10.0% or less, it is possible to suppress the deterioration in the meltability.

Preferably, the upper limit is 10.0% or less, 9.0% or less, 8.5% or less, or 8.0% or less. Further, the lower limit may be more than 0%, 1.0% or more, 1.5% or more, or 2.0% or more.

When the sum of the contents of the Al₂O₃ component and the ZrO₂ component, that is [Al₂O₃+ZrO₂], is large, the compressive stress of the surface increases when the reinforcing is performed. Preferably, the lower limit of [Al₂O₃+ZrO₂] is 10.0% or more, 11.0% or more, 12.0% or more, or 13.0% or more.

On the other hand, when [Al₂O₃+ZrO₂] is 22.0% or less, it is possible to suppress a deterioration in meltability. Therefore, the upper limit of [Al₂O₃+ZrO₂] is preferably 22.0% or less, 21.0% or less, 20.0% or less, or 19.0% or less.

The mass proportion SiO₂/(B₂O₃+Li₂O) is preferably 3.0 to 10.0. When the mass proportion is 3.0 to 10.0, it is possible to contribute to lower the viscosity of glass and make it easier to manufacture a glass, and furthermore, it is possible to increase the amount of alkaline ions that are ion-exchanged during chemical strengthening and manufacture an inorganic composition article having a desired CS30 (compressive stress at a depth of 30 μm from the outermost surface).

Therefore, the lower limit of the mass proportion SiO₂/(B₂O₃+Li₂O) is preferably 3.0 or more, more preferably 3.5 or more, and still more preferably 4.64 or more. The upper limit of the mass proportion SiO₂/(B₂O₃+Li₂O) is preferably 10.0 or less, more preferably 9.5 or less, and still more preferably less than 8.6.

When the sum of the contents of the SiO₂ component, the Li₂O component, the Al₂O₃ component, and the B₂O₃ component, that is [SiO₂+Li₂O+Al₂O₃+B₂O₃], is large, it is easily chemically strengthened, and possible to obtain high strength. Therefore, the lower limit of [SiO₂+Li₂O+Al₂O₃+B₂O₃] is preferably 75.0% or more, 77.0% or more, 79.0%, 80.0% or more, 83.0% or more, or 85.0% or more.

The P₂O₅ component is an essential component that may be added to let act as a crystal nucleating agent for a glass. When the content of the P₂O₅ components is 10.0% or less, it is possible to suppress a deterioration in resistance to devitrification of glass and phase-separation of glass.

Preferably, the upper limit is 10.0% or less, 8.0% or less, 6.0% or less, 5.0% or less, or 4.0% or less. The lower limit may be more than 0%, 0.5% or more, 1.0% or more, or 1.5% or more.

The K₂O component is an optional component involved with chemical strengthening when the content thereof is more than 0%. The lower limit of the content of the K₂O component may be more than 0%, 0.1% or more, 0.3% or more, or 0.5% or more.

Further, when the content of the K₂O components is 5.0% or less, it is possible to promote the precipitation of a crystal. Therefore, the upper limit of the content of the K₂O component may be preferably 5.0% or less, 4.0% or less, 3.5% or less, or 3.0% or less.

The Na₂O component is an optional component involved with chemical strengthening when the content thereof is more than 0%. When the content of the Na₂O component is 4.0% or less, it is possible to easily obtain a desired crystal phase. The upper limit of the content of the Na₂O component may be preferably 4.0% or less, 3.5% or less, more preferably 3.0% or less, and still more preferably 2.5% or less.

The MgO component, the CaO component, the SrO component, the BaO component, and the ZnO component are optional components that improve the low-temperature meltability when each content thereof is more than 0%, and may be contained as long as the effects of the present disclosure are not impaired.

Therefore, an upper limit of the content of the MgO component may preferably be 4.0% or less, 3.5% or less, 3.0% or less, or 2.5% or less. The lower limit of the content of the MgO component may be preferably more than 0%, 0.3% or more, or 0.4% or more.

Preferably, the upper limit of the content of the CaO component may be 4.0% or less, 3.0% or less, 2.5% or less, or 2.0% or less.

Preferably, the upper limit of the content of the SrO component may be 4.0% or less, 3.0% or less, 2.5% or less, or 2.0% or less.

Preferably, the upper limit of the content of the BaO component may be 5.0% or less, 4.0% or less, 3.0% or less, 2.5% or less, or 2.0% or less.

Preferably, the upper limit of the content of the ZnO component may be 10.0% or less, 9.0% or less, 8.5% or less, 8.0% or less, or 7.5% or less. In addition, the lower limit of the ZnO component may be preferably more than 0%, 0.5% or more, or 1.0% or more.

The crystallized glass may or may not contain the Nb₂O₅ component, the Ta₂O₅ component, and the TiO₂ component, respectively, as long as the effects of the present disclosure are not impaired.

The Nb₂O₅ component is an optional component that improves the mechanical strength of the crystallized glass when the content thereof is more than 0%. Preferably, the upper limit may be 5.0% or less, 4.0% or less, 3.5% or less, or 3.0% or less.

The Ta₂O₅ component is an optional component that improves the mechanical strength of the crystallized glass when the content thereof is more than 0%. Preferably, the upper limit may be 6.0% or less, 5.5% or less, 5.0% or less, or 4.0% or less.

The TiO₂ component is an optional component that improves the chemical durability of the crystallized glass when the content thereof is more than 0%. Preferably, the upper limit may be less than 1.0%, 0.8% or less, 0.5% or less, or 0.1% or less.

The crystallized glass may or may not contain a La₂O₃ component, a Gd₂O₃ component, a Y₂O₃ component, a WO₃ component, a TeO₂ component, and a Bi₂O₃ component, respectively, as long as the effects of the present disclosure are not impaired. The blending amount of each of the components may be 0% to 2.0%, 0% or more and less than 2.0%, or 0% to 1.0%, respectively.

Furthermore, the crystallized glass may or may not contain other components not mentioned above provided that the properties of the crystallized glass according to the present disclosure are not impaired. For example, the crystallized glass may contain metal components such as Yb, Lu, V, Cr, Mn, Fe, Co, Ni, Cu, Ag, and Mo (including oxides of these metals).

A Sb₂O₃ component may be contained as a glass clarifying agent. On the other hand, when the content of the Sb₂O₃ components is 3.0% or less, it is possible to suppress deterioration of transmittance in the short-wavelength range of the visible-light range. Therefore, the upper limit may be preferably 3.0% or less, more preferably 2.0% or less, still more preferably 1.0% or less, and yet still more preferably 0.6% or less.

Further, as a clarifying agent for glass, in addition to the Sb₂O₃ component, a SnO₂ component, a CeO₂ component, an As₂O₃ component, and one or more types selected from the group consisting of F, NOx, and SOx may or may not be contained. It is noted that the upper limit of the content of the clarifying agent may be preferably 2.0% or less, more preferably 1.0% or less, and most preferably 0.6% or less.

On the other hand, there is a tendency to avoid the use of components including Pb, Th, Tl, Os, Be, Cl, and Se, which are considered in recent years to be harmful chemical substances, and thus, it is preferable that these components are substantially not contained.

The compressive stress (CS [MPa]) of the compressive stress layer of the inorganic composition article according to the present disclosure is preferably 550 MPa or more, more preferably 600 MPa or more, and even more preferably 700 MPa or more. The upper limit of the compressive stress CS is, for example, 1400 MPa or less, 1300 MPa or less, 1200 MPa or less, or 1100 MPa or less. When the compressive stress layer has such a compressive stress value, it is possible to suppress the growth of cracks and increase the mechanical strength.

The compressive stress (CS30 [MPa]) at a depth of 30 μm from the outermost surface of the inorganic composition article according to the present disclosure is 120 MPa to 320 MPa. When CS30 is 120 MPa to 320 MPa, it is less likely to break when dropped onto a rough surface. CS30 is preferably 130 MPa to 310 MPa, more preferably 140 MPa to 300 MPa.

The central tensile stress (CT [MPa]) is an index of the degree of strengthening of glass by chemical strengthening. When CT value is high, pieces caused by breaking a glass are small and the glass tends to be shattered. Thus, in order to increase the impact resistance of a glass, the central tensile stress (CT [MPa]) is preferably 80 MPa or more, more preferably 90 MPa or more, and even more preferably 95 MPa or more. For example, the upper limit of the central tensile stress CT is 160 MPa or less, 155 MPa or less, 150 MPa or less, or 130 MPa or less. When the glass has such central tensile stress, it becomes possible to obtain a desired strengthened crystallized glass by chemical strengthening.

Although the thickness (DOLzero [μm]) of the compressive stress layer is not limited because it depends on the thickness of the crystallized glass, for example, when the thickness of the crystallized glass substrate is 0.7 mm, the thickness of the compressive stress layer may be 70 μm or more, or 100 μm or more, and the upper limit may be 180 μm or less, or 160 μm or less.

When the crystallized glass is used as a substrate, the lower limit of the thickness of substrate is preferably 0.1 mm or more, more preferably 0.3 mm or more, more preferably 0.4 mm or more, still more preferably 0.5 mm or more, the upper limit is preferably 2.0 mm or less, more preferably 1.5 mm or less, more preferably 1.1 mm or less, more preferably 1.0 mm or less, more preferably 0.9 mm or less, and even more preferably 0.8 mm or less.

The crystallized glass can be manufactured by the following method. That is, raw materials are uniformly mixed so that the content of each component falls within a prescribed range, and then melt-molded to produce raw glass. Next, the raw glass is crystallized to manufacture a crystallized glass.

Glass transition temperature (Tg) of the crystallized glass is preferably 610° C. or lower, more preferably 600° C. or lower, and still more preferably 590° C. or lower.

The heat treatment for crystal precipitation may be performed at a one-staged temperature or a two-staged temperature.

In the two-staged heat treatment, firstly, a nucleation step is performed in which the heat treatment is performed at a first temperature, and after the nucleation step, a crystal growth step is performed in which the heat treatment is performed at a second temperature higher than that in the nucleation step.

The first temperature in the two-staged heat treatment may be preferably 450° C. to 750° C., more preferably 500° C. to 720° C., and still more preferably 550° C. to 680° C. The retention time at the first temperature is preferably 30 minutes to 2000 minutes, and more preferably 180 minutes to 1440 minutes.

The second temperature in the two-staged heat treatment may be preferably 550° C. to 850° C., and more preferably 600° C. to 800° C. The retention time at the second temperature is preferably 30 minutes to 600 minutes, and more preferably 60 minutes to 400 minutes.

In the one-staged heat treatment, the nucleation step and the crystal growth step are continuously performed at the one-staged temperature. Typically, the temperature is raised to a predetermined heat treatment temperature, maintained for a certain period of time after reaching the predetermined heat treatment temperature, and then it is lowered.

In the case of one-staged heat treatment, the heat treatment temperature is preferably 600° C. to 800° C., and more preferably 630° C. to 770° C. Further, the retention time at the heat treatment temperature is preferably 30 minutes to 500 minutes, and more preferably 60 minutes to 400 minutes.

An example of a method for forming a compressive stress layer in an inorganic composition article includes a chemical strengthening method in which an alkali component present in a surface layer of crystallized glass is subjected to an exchange reaction with an alkali component with a larger ionic radius to form a compressive stress layer on the surface layer. Other methods include a heat strengthening method in which crystallized glass is heated and then rapidly cooled, and an ion implantation method in which ions are implanted into the surface layer of crystallized glass.

The inorganic composition article according to the present disclosure can be manufactured, for example, by the following chemical strengthening method.

A crystallized glass is contacted or immersed in a molten salt of a salt containing potassium, sodium or lithium, for example, a mixed salt or a complex salt of potassium nitrate (KNO₃), sodium nitrate (NaNO₃), and lithium nitrate (LiNO₃). The treatment of contacting or immersing the crystallized glass to or in the molten salt may be performed in one or two stages.

In the case of the two-stage chemical strengthening treatment, for example, firstly, the crystallized glass is contacted to or immersed in a mixed salt of potassium and sodium, a salt of sodium, or a mixed salt of potassium, sodium, and lithium, heated at 350° C. to 550° C. for 1 minute to 1440 minutes, preferably 15 minutes to 500 minutes, more preferably 30 minutes to 300 minutes. Subsequently, secondly, the resultant crystallized glass is contacted to or immersed in a potassium salt, a mixed salt of potassium and sodium, a mixed salt of potassium and lithium, or a mixed salt of potassium, sodium, and lithium, heated at 350° C. to 550° C., for 1 minute to 1440 minutes, preferably 60 minutes to 600 minutes.

In the case of the two-stage chemical strengthening treatment, for example, it is desirable to perform the first stage treatment using a single bath or a mixture bath of potassium (KNO₃) or sodium (NaNO₃) or lithium (LiNO₃), and to perform the second stage treatment using a salt containing potassium, sodium, and lithium, for example, a molten salt of a complex salt or a mixed salt of potassium nitrate (KNO₃), sodium nitrate (NaNO₃), and lithium nitrate (LiNO₃).

In the case of a one-staged chemical reinforcing treatment, for example, the crystallized glass is contacted to or immersed in a mixed salt containing potassium and sodium, a mixed salt containing potassium, sodium, and lithium, a mixed salt containing sodium, and a mixed salt containing sodium and lithium (a mixed salt containing potassium and/or sodium and/or lithium) heated at 350° C. to 550° C., for 1 minute to 1440 minutes, preferably 30 minutes to 500 minutes.

### EXAMPLES

### Example 1 and Comparative Example 1

### 1. Preparation of Inorganic Composition Article

Oxides, hydroxides, carbonates, nitrates, fluorides, chlorides, and metaphosphate compound corresponding to a raw material of each component of crystallized glass were selected, and the selected raw materials were weighed and mixed uniformly to have the compositions described in Table 1.

Next, the mixed raw materials were fed into a platinum crucible and melted in an electric furnace at 1300° C. to 1600° C. for 2 to 24 hours. Subsequently, the molten glass was stirred and homogenized, cast into a mold after lowering the temperature to 1000° C. to 1450° C., and then slowly cooled to produce raw glass. The obtained raw glass was heated under the crystallization conditions of the nucleation step and the crystal growth step described in Table 1 to prepare a crystallized glass.

The crystal phase contained in the crystallized glass was determined from the angles of the peaks appearing in an X-ray diffraction pattern measured using an X-ray diffraction analyzer (D8 Discover manufactured by Bruker). In the X-ray diffraction pattern of Example 1, a main peak (peak having the highest intensity and largest peak area) was observed in a position corresponding to the peak pattern of α-cristobalite and/or the α-cristobalite solid solution, and it was determined that the α-cristobalite and/or the α-cristobalite solid solution were precipitated as the main crystal phase. In Comparative Example 1, neither the peak of α-cristobalite nor the peak of α-cristobalite solid solution was confirmed by an X-ray diffraction analyzer (D8Discover, manufactured by Bruker), and then, the crystal phase was confirmed by analysis using EDX after confirmation a lattice image identified by an electron diffraction image. As a result, it was confirmed that the crystal phase of glass of Comparative Example 1 was MgAl₂O₄ and MgTi₂O₄.

The glass transition point (Tg) of the glass before crystallization of Example 1 was measured according to the Japan Optical Glass Manufactures' Association Standard JOGIS08-2019 “Measuring Method for Thermal Expansion of Optical Glass”.

The crystallized glass prepared in Example 1 and Comparative Example 1 was each cut and ground, and further the opposite surfaces were subjected to parallel polishing to result in a material thickness (substrate thickness) shown in Table 2 and Table 3 to obtain a crystallized glass substrate. The crystallized glass substrate was used as a base material to obtain a chemically strengthened crystallized glass substrate.

In Examples 1-1 to 1-9, a two-stage chemical strengthening were performed using the crystallized glass of Example 1 under the strengthening conditions shown in Tables 2 and 3. Specifically, in Examples 1-1 to 1-9, the substrate was chemically strengthened using a salt bath containing LiNO₃ as the salt bath of the first and/or second stage.

Using the crystallized glass of Comparative Example 1 in Comparative Example 1-1, and using the crystallized glass of Example 1 in Comparative Example 2-1, a two-stage chemical strengthening were performed under the strengthening conditions shown in Table 3.

TABLE 1

| | | | | Com. |
|---|---|---|---|---|
| | | | Ex. 1 | Ex. 1 |
| Composition | SiO₂ | | 64.81 | 55.56 |
| [mass. %] | Al₂O₃ | | 12.72 | 18.26 |
| | B₂O₃ | | 2.00 | |
| | P₂O₅ | | 2.14 | |
| | Li₂O | | 7.13 | 1.30 |
| | Na₂O | | 0.50 | 9.86 |
| | K₂O | | 0.73 | 1.92 |
| | MgO | | 1.02 | 7.96 |
| | CaO | | 0.41 | 0.85 |
| | SrO | | | |
| | BaO | | | |
| | ZnO | | 2.88 | |
| | ZrO₂ | | 5.60 | |
| | Nb₂O₅ | | | |
| | Ta₂O₅ | | | |
| | TiO₂ | | | 4.19 |
| | Sb₂O₃ | | 0.06 | 0.10 |
| | [symbol] | | 100.00 | 100.00 |
| | SiO₂ + Li₂O + Al₂O₃ + B₂O₃ | | 86.66 | 75.12 |
| | SiO₂/(B₂O₃ + Li₂O) | | 7.10 | 42.74 |
| | Al₂O₃ + ZrO₂ | | 18.32 | 18.26 |
| Crystallization | Nucleation | Temperature[° C.] | 600 | — |
| condition | | Retention time[h] | 5 | — |
| | Crystal | Temperature[° C.] | 660 | 655 |
| | growth | Retention time[h] | 5 | 5 |

| | | |
|---|---|---|
| Tg [° C.] | 579 | 599 |

### 2. Evaluation of Inorganic Composition Article

The following properties were measured for the obtained strengthened crystallized glass substrate and a drop test was performed. The results are shown in Table 2 and Table 3.

### (1) Measurement of Stress

A compressive stress value (CS) of the outermost surface was measured using glass surface stress meter FSM-6000LE Series manufactured by Orihara Industrial Co. Ltd., and a light source having a wavelength of 365 nm was used as the light source for the measurement device.

A compressive stress (CS30) at a depth of 30 μm from the outermost surface was measured using SLP-1000 series. A light source having a wavelength of 518 nm was used as the light source for the measurement device.

As the refractive index used for the measurement of CS and CS30, the refractive index values at 365 nm and 518 nm were used. It is noted that the refractive index value was calculated by using a quadratic approximation expression from the measured values of the refractive index at the wavelengths of a C-line, a d-line, an F-line, and a g-line according to the V-block method specified in JIS B 7071-2: 2018.

As the photoelastic constant used for the measurement of CS and CS30, the photoelastic constant values at 365 nm and 518 nm were used. The photoelastic constant can be calculated from the measured values of the photoelastic constant at a wavelength of 435.8 nm, a wavelength of 546.1 nm, and a wavelength of 643.9 nm by using a quadratic approximation expression. As the photoelastic constant, 31.3 was used at 365 nm and 30.1 was used at 518 nm in Example 1. As the photoelastic constant, 28.7 was used at 365 nm and 27.8 was used at 518 nm in Comparative Example 1.

The photoelastic constant (β) was determined by polishing the sample on the opposite surfaces to form a disk shape with a diameter of 25 mm and a thickness of 8 mm, applying a compressive load to the disk in a specified direction, measuring an optical path difference generated at the center of the glass, and calculating the constant using the relational expression δ=β*d*F. In the relational expression, δ (nm) denotes the optical path difference, d (mm) denotes the glass thickness, and F (MPa) denotes the stress.

A depth DOLzero (μm) when the compressive stress of the compressive stress layer was 0 MPa and a central tensile stress (CT) were measured by using a scattered light photoelastic stress meter SLP-1000. A light source having a wavelength of 518 nm was used as the light source for measurement.

The refractive index value at a wavelength of 518 nm was calculated by using a quadratic approximation expression from the measured values of the refractive index at the wavelengths of the C-line, the d-line, the F-line, and the g-line according to the V-block method specified in JIS B 7071-2:2018.

The photoelastic constant at the wavelength of 518 nm used for the measurement of DOLzero and CT can be calculated from the measured values of the photoelasticity constant at the wavelength of 435.8 nm, the wavelength of 546.1 nm, and the wavelength of 643.9 nm by using the quadratic approximate expression. In Example 1, 30.1 was used. In Comparative Example 1, 27.8 was used as the photoelastic constant.

### (2) Substrate Drop Test

A drop test using a sandpaper was performed in the following method. The drop test simulates a drop onto asphalt.

As a drop test sample, a glass substrate having the same dimensions as the inorganic composition article was attached to the inorganic composition article (vertical 156 mm×horizontal 71 mm) to obtain the drop test sample. The weights of all the drop test samples were 46 g. A sandpaper with a roughness of #80 was laid on the stainless-steel base, and the drop test sample was dropped onto the base from a height of 20 cm with the inorganic composition article facing downward. After the drop, if the inorganic composition article did not crack, the height was 5 cm raised, and the drop was repeated by raising the height until the crack occurred. Tests were performed for three times (n1 to n3) to calculate an average height at which the inorganic composition article was cracked in n1 to n3. The results are shown in Tables 2 to 3.

TABLE 2

| | | Ex. 1-1 | Ex. 1-2 | Ex. 1-3 | Ex. 1-4 | Ex. 1-5 | Ex. 1-6 |
|---|---|---|---|---|---|---|---|
| Base material | | Ex. 1 | Ex. 1 | Ex. 1 | Ex. 1 | Ex. 1 | Ex. 1 |
| Substrate thickness (mm) | | 0.59 | 0.59 | 0.59 | 0.59 | 0.59 | 0.53 |
| (Actual measurement value) | | | | | | | |
| Strengthening | Stage 1 | NaNO₃ | NaNO₃ | NaNO₃ | NaNO₃ | NaNO₃ | NaNO₃ |
| Condition | | 380° C. × | 380° C. × | 380° C. × | 380° C. × | 380° C. × | 380° C. × |
| | | 100 min | 60 min | 100 min | 60 min | 100 min | 60 min |
| | Stage 2 | KNO₃ 70: | KNO_{₃} 50: | KNO₃ 50: | KNO₃ 50: | KNO₃ 50: | KNO₃ 40: |
| | | NaNO₃ 1: | NaNO₃ 1: | NaNO₃ 1: | NaNO₃ 1: | NaNO₃ 1: | NaNO₃ 1: |
| | | LiNO₃ 0.05 | LiNO₃ 0.05 | LiNO₃ 0.05 | LiNO₃ 0.05 | LiNO₃ 0.05 | LiNO₃ 1 |
| | | 400° C. × | 400° C. × | 400° C. × | 400° C. × | 400° C. × | 400° C. × |
| | | 300 min | 300 min | 300 min | 420 min | 420 min | 300 min |

| | | | | | | |
|---|---|---|---|---|---|---|
| CS (MPa) | 818 | 772 | 778 | 774 | 773 | |
| CS30 (MPa) | 140 | 146 | 154 | 137 | 141 | 172 |
| CT (MPa) | 105 | 107 | 114 | 113 | 119 | 115 |
| DOLzero (μm) | 107 | 103 | 106 | 114 | 117 | 98 |
| Sustrate drop test (cm) | 65 | 75 | 90 | 70 | 70 | — |

TABLE 3

| | | | | | Comparative | |
|---|---|---|---|---|---|---|
| | | | | | Ex. 1-1 | Comparative |
| | | Ex.1-7 | Ex.1-8 | Ex.1-9 | Comparative | Ex. 2-1 |
| Base material | | Ex.1 | Ex.1 | Ex.1 | Ex. 1 | Ex. 1 |
| Substrate thickness (mm) | | 0.53 | 0.57 | 0.61 | 0.70 | 0.53 |
| (Actual measurement value) | | | | | | |
| Strengthening | Stage 1 | NaNO₃ | KNO₃ 2: | KNO₃ 2: | KNO₃ 1: | NaNO₃ |
| Condition | | | NaNO₃ 1: | NaNO₃ 1: | NaNO₃ 2 | |
| | | | LiNO₃ 0.06 | LINO₃ 0.06 | | |
| | | 380° C. × | 420° C. × | 425° C. × | 470° C. × | 380° C. × |
| | | 100 min | 100 min | 130 min | 400 min. | 80 min |
| | Stage 2 | KNO₃ 40: | KNO₃ 90: | KNO₃ 90: | KNO₃ 50: | KNO₃ 10: |
| | | NaNO₃ 1: | NaNO₃ 1 | NaNO₃ 1 | NaNO₃ 1 | NaNO₃ 1 |
| | | LiNO₃ 1 | | | | |
| | | 400° C. × | 400° C. × | 400° C. × | 400° C. × | 400° C. × |
| | | 300 min | 60 min | 60 min | 90 min. | 240 min. |

| | | | | | |
|---|---|---|---|---|---|
| CS (MPa) | | | | 952 | |
| CS30 (MPa) | 179 | 231 | 259 | 92 | 276 |
| CT (MPa) | 125 | 127 | 142 | 56 | 170 |
| DOLzero (μm) | 103 | 92 | 105 | 116 | 99 |
| Sustrate drop test (cm) | — | 55 | 80 | 60 | — |

Although several embodiments and/or examples according to the present disclosure have been described in detail above, those skilled in the art will readily be able to make numerous modifications to these illustrative embodiments and/or examples without substantially departing from the novel teachings and advantages of the present disclosure. Accordingly, all such variations are intended to be within the scope of the present disclosure.

The contents of all documents cited in the present specification and of the application from which the present application claims priority under the Paris Convention are incorporated by reference in their entirety.

What is claimed is:

1. An inorganic composition article obtained by strengthening a crystallized glass, wherein
the crystallized glass comprises one or more kinds selected from α-cristobalite and α-cristobalite solid solution as a main crystal phase,
the crystallized glass comprises, by mass % in terms of oxide,
a content of a SiO₂ component of 50.0% to 75.0%,
a content of a Li₂O component of 3.0% to 10.0%,
a content of an Al₂O₃ component of 5.0% or more and less than 15.0%,
a content of a B₂O₃ component of more than 0% and 10.0% or less,
a content of a P₂O₅ component of more than 0% and 10.0% or less, and
a mass proportion SiO₂/(B₂O₃+Li₂O) of 3.0 to 10.0, and
the inorganic composition article has a compressive stress layer on the surface, and has a central tensile stress (CT) of 80 MPa to 160 MPa.

2. The inorganic composition article according to claim 1, wherein in the crystallized glass comprises, by mass % in terms of oxide,
a content of a ZrO₂ component is more than 0% and 10.0% or less, and
a total content of the Al₂O₃ component and the ZrO₂ component is 10.0% or more.

3. The inorganic composition article according to claim 1 or 2, wherein in the crystallized glass, by mass % in terms of oxide,
a content of a K₂O component is 0% to 5.0%.

4. The inorganic composition article according to claim 1 or 2, wherein in the crystallized glass, by mass % in terms of oxide,
a content of a Na₂O component is 0% to 4.0%,
a content of a MgO component is 0% to 4.0%,
a content of a CaO component is 0% to 4.0%,
a content of a SrO component is 0% to 4.0%,
a content of a BaO component is 0% to 5.0%,
a content of a ZnO component is 0% to 10.0%, and
a content of a Sb₂O₃ component is 0% to 3.0%.

5. The inorganic composition article according to claim 1 or 2, wherein
in the crystallized glass, by mass % in terms of oxide,
a content of a Nb₂O₅ component is 0% to 5.0%,
a content of a Ta₂O₅ component is 0% to 6.0%, and
a content of a TiO₂ component is 0% or more and less than 1.0%.

6. The inorganic composition article according to claim 1 or 2, wherein a glass transition temperature (Tg) of a glass before crystallization of the crystallized glass is 610° C. or less.

7. The inorganic composition article according to claim 1 or 2, which is obtained by chemically strengthening the crystallized glass using a salt-bath comprising lithium.
